(19) United States
(12) Patent Application Publication
(10) Pub. No.: US 2006/0207401 A1
(43) Pub. Date: Sep. 21, 2006

(54) Cutting tool assembly

(75) Inventor: Jun Yow Wu, Taipei County (TW)

Correspondence Address: BIRCH STEWART KOLASCH & BIRCH, PO BOX 747, FALLS CHURCH, VA, 22040-0747, US

(73) Assignee: TEX YEAR INDUSTRIES INC.

(21) Appl. No.: 11/240,577

(22) Filed: Oct. 3, 2005

(30) Foreign Application Priority Data
Mar. 16, 2005 (JP) JP2005-001358 U

(51) Int. Cl. B26D 5/08

(52) U.S. Cl. 83/614

(57) ABSTRACT

Disclosed is a cutting tool assembly, which includes a body, a tool rack holding a set of cutting tools for different cutting purposes, and an operating unit movably mounted on the body and connected to the tool rack for moving by the user relative to the body to selectively shift the cutting tools into the cutting position, where the cutting tool which is in the cutting position is forced downwards by a stop member in the body to have the respective cutter extend out of the bottom tool access of the body for cutting.

### BACKGROUND OF THE INVENTION

1. Field of the Invention

The present invention relates generally to cutting tools and more particularly, to a cutting tool assembly, which carries a set of cutting tools for different cutting purposes.

2. Description of the Related Art

A conventional cutting tool provides only one cutting mode, normally, a linear cutting mode. This single-mode cutting tool cannot satisfy the demand for multiple cutting modes such as making a perforated tearing line on a sheet member, making a dent on a sheet member, or cutting off a sheet member. For different cutting modes, the user may have to prepare several different cutting tools.

Taiwan Patent No. 221111 discloses a cutting tool. As shown in FIG. 4, the cutting tool 10 comprises a rotary member 11. The rotary member 11 has a first spiral guide 111, a second spiral guide 112, and a third spiral guide 113 corresponding to a first cutter 12, a second cutter 13 and a third cutter 14 respectively. Rotating the rotary member 11 through one angle causes one of the spiral guides 111, 112, 113 to force the first cutter 12, the second cutter 13 or the third cutter 14 downwards into contact with the sheet member to be cut. When the external biasing force disappeared, the rotary member 11 is returned to its former position by a return spring 15, and at the same time spring strips 131, 141 push the cutters 13, 14 back to their former positions.

This design of cutting tool still has drawbacks as follows:

1. When wishing to force the cutter 12, 13, 14 into contact with the sheet member, the user must apply a force to the rotary member 11 to overcome the spring power of the return spring 15 and to keep one of the cutters 12, 13, 14 in the extended position for cutting. It is a hard task to the user, more particularly, a women user to cut a big number of sheet members.

2. When rotating the rotary member 11 to a certain angle to force the second spiral guide 112 or third spiral guide 113 against the second cutter 13 or third cutter 14, the first cutter 12 that is disposed at the center will be forced outwards by the first spiral guide 111 at first. When continuously rotating the rotary member 11, the cutter 13 will be moved over the peach of the first spiral guide 111 into the next spiral guide and than gradually retracted, and at the same time the second cutter 13 or third cutter 14 will be gradually forced outwards by the second spiral guide 112 or third spiral guide 113. This design has the center (first) cutter 12 and the two side cutters (second and third cutters) 13, 14 to be moved at the same time. Because there is no means to retain the cutters, the positioning of every cutter must be manually controlled by the user. Further, the user cannot judge which cutter has been forced out for cutting when rotating the rotary member, and a false cutting result may occur. Further, if the rotary member 11 slips from the user's hand during cutting, the cutters will displace relative to the respective spiral guides 111, 112, 113, resulting in a cutting error.

Therefore, it is desirable to provide a cutting tool assembly, which eliminates the aforesaid drawbacks.

### SUMMARY OF THE INVENTION

The present invention has been accomplished under the circumstances in view. It is the main object of the present invention to provide a cutting tool assembly, which can be conveniently operated to selectively shift one of a set of cutting tool into the cutting position for cutting.

According to one aspect of the present invention, the cutting tool assembly comprises a body, a tool rack holding a set of cutting tools for different cutting purposes, and an operating unit movably mounted on the body and connected to the tool rack for moving by the user relative to the body to selectively shift the cutting tools into the cutting position, where the cutting tool which is in the cutting position is forced downwards by a stop member in the body to have the respective cutter extend out of the bottom tool access of the body for cutting.

According to another aspect of the present invention, each cutting tool is mounted with a spring member, which returns the respective cutting tool to a received status inside the tool rack when moved away from the cutting position.

According to still another aspect of the present invention, the body has the top side thereof printed with tool signs corresponding to the types of the cutting tools carried in the tool rack, and the operating unit has a window through which the tool sign corresponding to the cutting tool in the cutting position is viewed.

### BRIEF DESCRIPTION OF THE DRAWINGS

FIG. 1 is an exploded view of a cutting tool assembly according to the prior art.

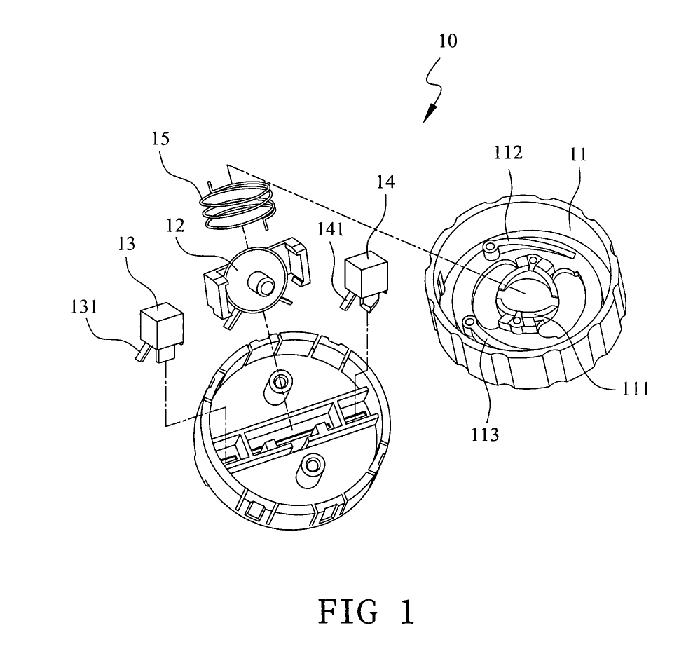

FIG. 2 is a schematic elevational view showing a cutting tool assembly installed in a table according to the present invention.

FIG. 3 is an exploded view of the cutting tool assembly according to the present invention.

FIG. 4 is a sectional elevation of the cutting tool assembly according to the present invention.

FIG. 5 is schematic drawings showing the cutting tool shifting operation of the present invention.

FIG. 6 is schematic drawings showing different sides of the cutting tool assembly according ton the present invention.

### DETAILED DESCRIPTION OF THE INVENTION

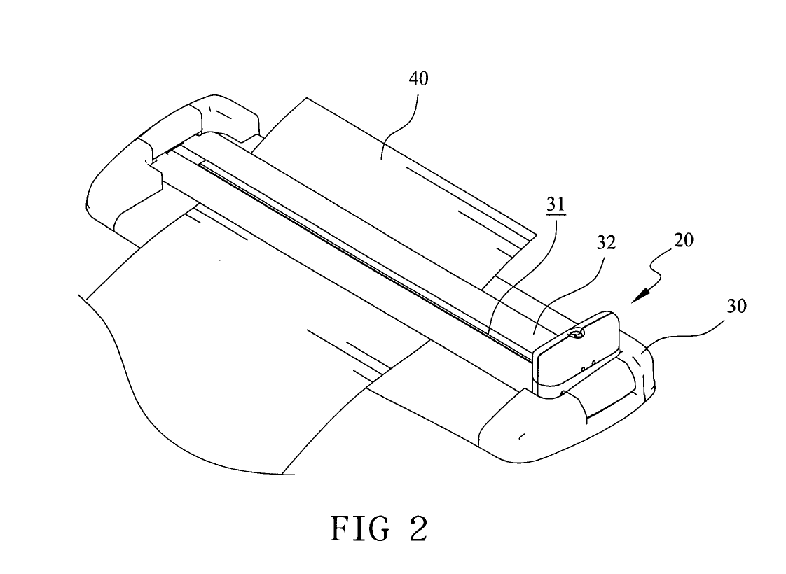

Referring to FIG. 2, a cutting tool assembly 20 is installed in a cutting table 30. The cutting table 30 is an open carrier having an elongated slot 31 adapted to guide movement of the cutting tool assembly 20, two pressure members 32 arranged along two opposite lateral sides of the elongated slot 31 and adapted to hold down a sheet member 40 across the elongated slot 31. Moving the cutting tool assembly 20 along the elongated slot 31 causes the cutting tool assembly 20 to cut the sheet member 40 into two pieces.

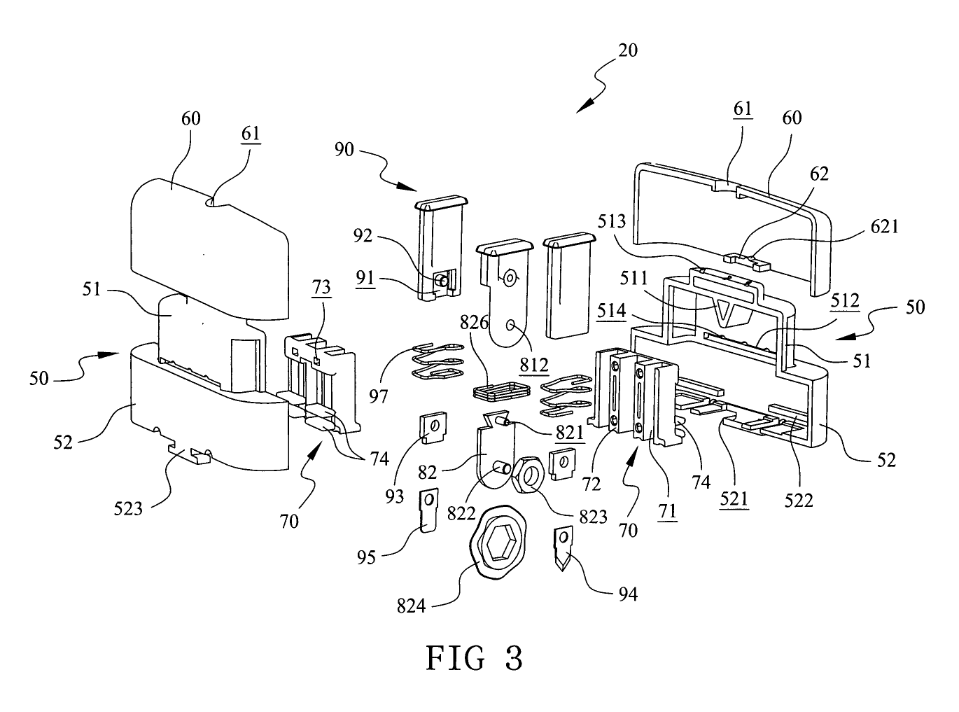

Referring to FIG. 3, the cutting tool assembly 20 comprises a body 50, an operating unit 60, and a tool rack 70. The body 50 is formed of two symmetrical half shells, having an upper part 51 and a lower part 52. The upper part 51 has a width smaller than the lower part 52, an arched stop member 511 on the inside, and a sliding slot 512 at a suitable location.

The lower part 52 has a tool access hole 521 formed in the bottom side, two horizontal rails 522 arranged at two sides relative to the tool access hole 521, and a bottom coupling member 523 for coupling to the elongated slot 31 of the table 30.

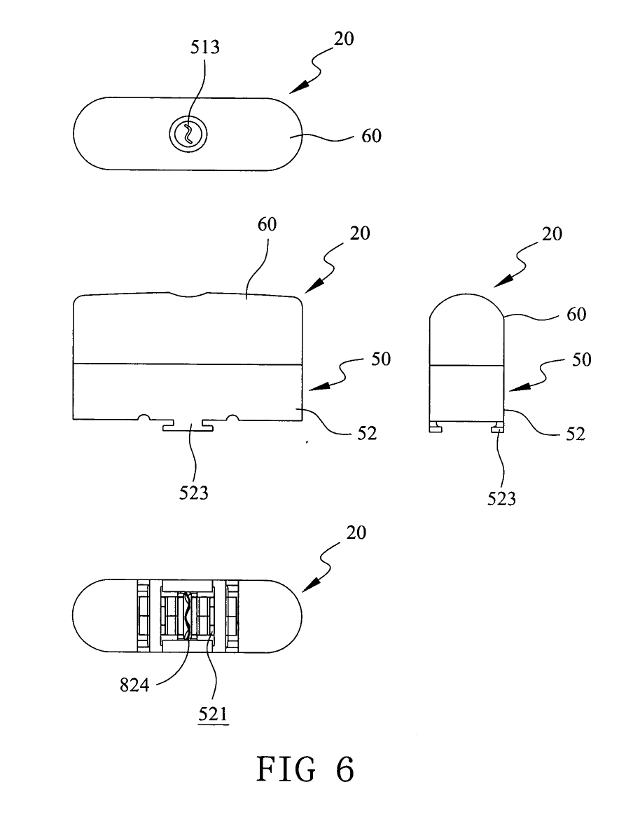

Further, the upper part 51 has the top surface thereof printed with cutter signs 513 (see also FIG. 6) corresponding to the shape of each of the cutters mounted inside the body 50. The upper part 51 further has retaining notches 514 in the sliding slot 512.

The operating unit 60 is formed of two symmetrical half shells and mounted on one side of the upper part 51 of the body 50 remote from the lower part 52, having a top opening 61, a bottom clamping member 62, and a protruding retaining portion 621 protruded from the bottom clamping member 62 for selectively engaging one of the retaining notches 514. After installation of the operating unit 60 in the body 50, the opening 61 forms a window through which the user can see one cutter sign 513 corresponding to the selected cutter.

The tool rack 70 is formed of two symmetrical half shells fastened together to hold cutters in the body 50, comprising a plurality of longitudinal holes 71, partition members 72 that separate the longitudinal holes 71, retaining holes 73 formed in the partition member 72 and forced into engagement with the bottom clamping member 62 of the operating unit 60, and a plurality of guide blocks 74 disposed at different elevations and coupled to the horizontal rails 522 of the body 50 for guiding horizontal movement of the tool rack 70 along the rails 522.

Regular cutting modes include a first cutting mode to cut the sheet member 40 into two pieces, a second cutting mode to make a perforated tear line on the sheet member 40, and a third cutting mode to make dents on the sheet member 40. The cutting tool assembly 20 uses three different cutting tools covering the aforesaid three cutting modes, wherein one cutting tool has a cutting blade for making a tangent arc, another cutting tool has a die for making a dent, and the other cutting tool has a sharp blade for cut-off purpose. Because the cutting tool assembly 20 is linearly movably mounted on the table 30 for cutting the sheet member 40, it is preferably to have the cutting tool rotatable for making a perforated tearing line on the sheet member 40. Therefore, the cutting tool assembly 20 comprises at least one rotary cutting tool 80, and a fixed cutting tool 90.

The aforesaid rotary cutting tool 80 comprises two sideboards 81 and 82, a wheel 823, and an annular cutter blade 824. One sideboard 81 has two mounting holes 811 and 812 disposed at different elevations. The other sideboard 82 has two mounting rods 821 and 822 respectively fastened to the mounting holes 811 and 812. The wheel 823 is rotatably mounted on the bottom mounting rod 822 between the two sideboards 81 and 82. The annular cutter blade 824 is fixedly mounted around the periphery of the wheel 823 between the two sideboards 81 and 82 and partially protruding over the bottom side of the sideboards 81 and 82 for making a perforated tearing line on the sheet member 40 when rotated with the wheel 823.

The fixed cutting tool 90 has bottom recess 91 disposed at one side, a locating rod 92 suspending in the bottom recess 91, and a holding down plate 93 fitted into the bottom recess 91 and affixed to the locating rod 92 to hold down a cut-off cutting blade or a die.

According to the preferred embodiment of the present invention, the cutting tool assembly 20 comprises one rotary cutting tool 80 and two fixed cutting tools 90. The rotary cutting tool 80 is provided with an annular cutter blade 824. The two fixed cutting tools 90 are respectively provided with a cut-off cutting blade 94 or a die 95.

The aforesaid rotary cutting tool 80 and fixed cutting tools 90 each have a top flange 825 or 96, and a spring 826 or 97 supported below the top flange 825 or 96. The top flange 825 or 96 has a chamfered edge and is greater than the width of the longitudinal holes 71 of the tool rack 70.

The cutting tools 80 and 90 are respectively mounted in the longitudinal holes 71 of the tool rack 70, keeping the respective springs 826 and 97 stopped between the top flanges 825 and 96 of the cutting tools 80 and 90 and the tool rack 70 to give a return force to the respective cutting tools 80 and 90. The guide blocks 74 of the tool rack 70 are attached to the horizontal rails 522 at two sides to guide movement of the tool rack 70 along the horizontal rails 522. The tool rack 70 is mounted inside the body 50. The bottom clamping member 62 of the operating unit 60 is inserted through the sliding slot 512 of the upper part 51 of the body 50 and fastened to the retaining holes 73 of the tool rack 70, allowing movement of the tool rack 70 with the operating unit 60. At final, the two symmetrical half shells of the body 50 are fastened together, forming the cutting tool assembly 20.

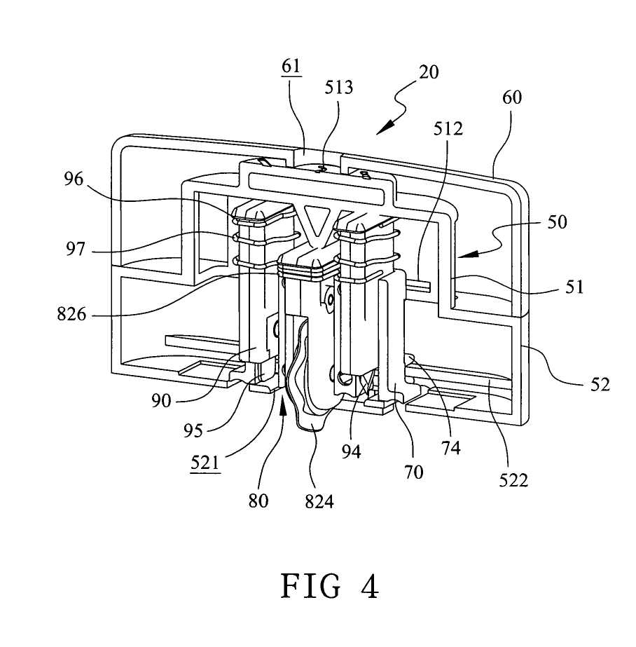

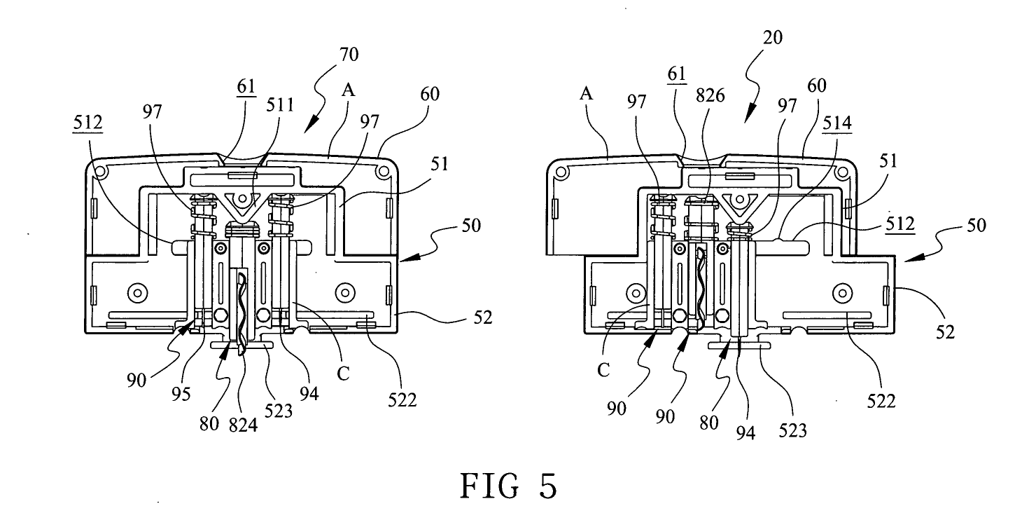

Changing of the cutting tool in operation is achieved by means of the pushing the operating unit 60. Referring to FIGS. 4 and 5, when changing the cutting tool in operation from the rotary cutting tool 80 to one fixed cutting tool 90, push the operating unit 60 to move the rotary cutting tool 80 away from the stop member 511 of the body 50 and to disengage the retaining portions 621 from the retaining notches 514 in the sliding slot 512 of the body 50, allowing the rotary cutting tool 80 to be moved upwards in the respective longitudinal hole 71 by the spring power of the respective spring 826 to receive the an annular cutter blade 824 from the tool access 521 into the inside of the tool rack 70, and at the same time the top flange 96 of the respective fixed cutting tool 90 is forced against the side edge of the stop member 511 of the body 50 to compress the respective spring 97 and to further force the fixed cutting tool 90 downwards in the respective longitudinal hole 71. During downward movement of the fixed cutting tool 90 in the respective longitudinal hole 71, the cut-off cutting blade 94 (or die 95) is gradually extending out of the tool access 521 of the body 50. When the retaining portion 621 is forced into engagement with the notches 514 in the sliding slot 512 of the body 50, the stop member 511 of the body 50 is stopped at the top side of the fixed cutting tool 90. At this time, the fixed cutting tool 90 is firmly held in the cutting position by means of the stop member 511 of the body 50 and the respective spring 97.

After the selected cutting tool has been set in position, the user can see the cutter sign 513 of the cutting tool in the cutting position through the window of the opening 61 of the operating unit 60. Therefore, the user can know the current cutting tool in the cutting position when viewing the window of the opening 61 of the operating unit 60.

As indicated above, the present invention provides a cutting tool assembly, which has a set of cutting tools for different cutting purposes that can be conveniently and alternatively shifted to the cutting position for cutting.

Although a particular embodiment of the invention has been described in detail for purposes of illustration, various modifications and enhancements may be made without departing from the spirit and scope of the invention. For example, oscillator means may be used to atomize water into a fine spray. Accordingly, the invention is not to be limited except as by the appended claims.

What is claimed is:

1. A cutting tool assembly installed in a cutting table for cutting a sheet member being inserted through said cutting table, the cutting tool assembly comprising:
a body mounted in said cutting table and linearly movable forwards/backwards on said cutting table, said body comprising a stop member on the inside for pushing a cutting tool out of said body;
an operating unit mounted on said body and movable relative to said body;
a tool rack suspending inside said body and movable with said operating unit, said tool rack having a plurality of longitudinal holes arranged in parallel each for holding a respective cutting tool;
a plurality of cutting tools, said cutting tools each being equipped with a respective cutter, said cutting tools each having a top flange, said top flange having a chamfered peripheral edge and being greater than the transverse width of said longitudinal holes of said tool rack; and
a plurality of spring members respectively mounted on said cutting tools and stopped between the top flanges of said cutting tool and the topmost edge of said tool rack;
wherein said tool rack is movable with said operating unit relative to said body to alternatively shift the top flanges of said cutting tools into contact with said stop member of said body to have the cutter of the cutting tool that is forced into contact with the stop member of said body be extended out of said body for cutting.

2. The cutting tool assembly as claimed in claim 1, wherein said body is comprised of two symmetrical half shells fastened together, comprising an upper part and a lower part, said upper part having a transverse width shorter than said lower part.

3. The cutting tool assembly as claimed in claim 2, wherein said upper part has a sliding slot for guiding movement of said operating unit relative to said body, and a plurality of retaining notches in said sliding slot for receiving said cutting tools.

4. The cutting tool assembly as claimed in claim 2, wherein said lower part has a bottom tool access, and two rails at two sides of said bottom tool access.

5. The cutting tool assembly as claimed in claim 2, wherein said upper part has a top side printed with tool signs corresponding to the cutters installed in said cutting tools.

6. The cutting tool assembly as claimed in claim 5, wherein said operating unit is comprised of two symmetrical half shells fastened together and coupled to said upper part of said body, said operating unit having a window in a top side thereof through which one of said tool signs is viewed.

7. The cutting tool assembly as claimed in claim 3, wherein said operating unit comprises a clamping member inserted through said sliding slot of said upper part of said body and fastened to said tool rack, and a retaining portion protruded from said clamping member for selectively engaging said retaining notches in said sliding slot.

8. The cutting tool assembly as claimed in claim 4, wherein said tool rack is comprised of symmetrical half shells, having a plurality of guide blocks respectively coupled to said rails of said lower part of said body at two sides to guide movement of said tool rack along said rails.

9. The cutting tool assembly as claimed in claim 1, wherein said cutting tools include a rotary cutting tool and at least one fixed cutting tool.

10. The cutting tool assembly as claimed in claim 9, wherein said rotary cutting tool comprises a first sideboard, said first sideboard having two mounting holes disposed at different elevations, a second sideboard fastened to said fist sideboard, said second sideboard having an upper mounting rod and a lower mounting rod respectively fastened to the mounting holes of said first sideboard, a wheel rotatably mounted on said lower mounting rod between said first sideboard and said second sideboard, and a cutter fixedly mounted on said wheel.

11. The cutting tool assembly as claimed in claim 10, wherein the cutter of said rotary cutting tool is an annular cutting blade.

12. The cutting tool assembly as claimed in claim 9, wherein said at least one fixed cutting tool each has a bottom recess at one side thereof, a locating rod suspending in said bottom recess, a cutter mounted on said locating rod, and a holding down plate fitted into said bottom recess and fastened to said locating rod to hold down the cutter at said locating rod.

13. The cutting tool assembly as claimed in claim 12, wherein the cutter of each of said at least one fixed cutting tool is a cut-off cutting blade.

14. The cutting tool assembly as claimed in claim 12, wherein the cutter of each of said at least one fixed cutting tool is a die.

15. The cutting tool assembly as claimed in claim 1, wherein said sheet member is paper.
